(19) United States
(12) Patent Application Publication
(10) Pub. No.: US 2023/0024645 A1
(43) Pub. Date: Jan. 26, 2023

(54) SYSTEMS AND METHODS FOR IDENTIFYING ELECTRIC POWER DELIVERY SYSTEM EVENT LOCATIONS USING MACHINE LEARNING

(71) Applicant: Schweitzer Engineering Laboratories, Inc., Pullman, WA (US)

(72) Inventor: Kei Hao, Anaheim, CA (US)

(73) Assignee: Schweitzer Engineering Laboratories, Inc., Pullman, WA (US)

(21) Appl. No.: 17/378,286

(22) Filed: Jul. 16, 2021

(51) Int. Cl. H02J 3/00; G06K 9/62; G06N 20/00

(52) U.S. Cl. CPC H02J 3/001; H02J 3/0073; H02J 3/003; G06K 9/6256; G06N 20/00

(57) ABSTRACT

Systems and methods for determining a location of an event in an electric power delivery system using a machine learning engine are provided. The machine learning engine may be trained based on a topology of the electric power delivery system, where the topology may be a layout of line sections and corresponding sensors of the electric power delivery system. Based on the topology, one or more training matrices that indicate possible event locations may be generated. In turn, the machine learning engine may be trained using the training matrices and logistic regression models to determine locations of events that occur during operation of the electric power delivery system.

### BACKGROUND

This disclosure relates to monitoring an electric power delivery system. More particularly, this disclosure relates to identifying locations of events, such as faults, on the electric power delivery system.

Electric power delivery systems carry electricity from a generation facility to residential communities, factories, industrial areas, and other electricity consumers. However, power delivery system events, such as a fault on a line section, may interrupt normal operation. An event in the electric power system may be defined as any abnormal condition of the electric power system that affects normal power system operation and may involve the electrical failure of equipment, such as transformers, generators, sensors, etc. With numerous equipment in the electric power system, it may be difficult to quickly pinpoint an accurate location of an event.

### BRIEF DESCRIPTION OF THE DRAWINGS

FIG. 1 is a schematic diagram of an electric power delivery system with line sensors disposed in various locations, in accordance with an embodiment;

FIG. 2 is a simplified architectural view of communication from the line sensors to other components of the electric power delivery system of FIG. 1, in accordance with an embodiment;

FIG. 3 is a schematic topology of the electric power delivery system of FIG. 1, in accordance with an embodiment.

FIG. 4 is a schematic topology showing events (e.g., faults) within the electric power delivery system of FIG. 1, in accordance with an embodiment;

FIG. 5A is a schematic topology showing an event location within the electric power delivery system of FIG. 1 and a corresponding probability of the event location, in accordance with an embodiment;

FIG. 5B is a schematic topology showing the event location of FIG. 5A and a corresponding probability of the event location when a sensor the electric power delivery system has failed, in accordance with an embodiment; and

FIG. 6 is a flowchart of a process used to determine location of the events (e.g., faults) of FIG. 4 using machine learning techniques, in accordance with an embodiment.

### DETAILED DESCRIPTION

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features. Furthermore, the phrase A “based on” B is intended to mean that A is at least partially based on B. Moreover, unless expressly stated otherwise, the term “or” is intended to be inclusive (e.g., logical OR) and not exclusive (e.g., logical XOR). In other words, the phrase “A or B” is intended to mean A, B, or both A and B.

The embodiments herein are directed to determining a location of an event, such as a fault (e.g., faulted line section), in an electric power delivery system using machine learning techniques. An event in the electric power delivery system may be defined as any abnormal condition of the system, which may involve the electrical failure of equipment, such as transformers, generators, sensors, etc. One specific type of event is a fault. For example, a faulted line section, which refers to a portion of a line section (e.g., a small portion of a line section) of the electric power delivery system associated with the fault, may disrupt normal power operations. As such, it may be helpful to quickly determine the location of the event (e.g., faulted line section), such that the event (e.g., fault) may be corrected.

Any suitable sensor network system may monitor electrical parameters of the electric power delivery system. One example system is the Fault and Load Transmitter and Receiver System using SEL-FLR and SEL-FLT products by Schweitzer Engineering Laboratories. For example, the fault and load transmitter/fault and load receiver system (e.g., FLT/FLR system) may include one or more controllers (e.g., a Real-Time Automation Controller (RTAC) by Schweitzer Engineering Laboratories) that are communicatively coupled to collectors (e.g., a fault and load receiver (FLR) by Schweitzer Engineering Laboratories) and sensors (e.g., a fault and load transmitter (FLT) by Schweitzer Engineering Laboratories). The sensor network system may include any suitable number and type of collectors such as wireless line collectors. Each of the collectors may be communicatively couple to any suitable number and type of sensors such as wireless line sensors, power system sensors, intelligent electronic devices (IEDs), electrical measurement sensors, and relays. A sensor may detect an event in the electric power delivery system and send a signal regarding the event to a corresponding collector. The collector may record the number of events detected by the sensor and transmit this information to a controller or an operator of the electric power delivery system.

In some instances, the sensors may include indicator lights (e.g., light emitting diodes (LEDs)) that indicate a presence of events (e.g., faults) or anomalies. The indicator lights may remain visible after an event occurrence to enable an operator to perform a search for a location of the event. Despite such event indication features of the sensors, identifying the location of the event (e.g., faulted line section) may be time-consuming and inefficient via manual processes. With numerous collectors and sensors within the sensor network system, checking electrical parameters of each sensor may be computationally intensive. For example, there may be 10,000 possible event locations if the electric power delivery system includes 10,000 sensors. In some embodiments, the electrical parameters of a sensor may include a current or voltage measurement of a location where the sensor is located. In other embodiments, the electrical parameters may include an event status. The event status may indicate whether there is an event occurrence at the location according to the sensor.

After an event is detected, an operator may patrol power transmission or distribution lines of the electric power delivery system by following the indicator lights of the sensors until the event location is identified. In some cases, the sensor network system may be communicatively coupled to a Supervisory Control and Data Acquisition (SCADA) system. The operator may also analyze a Supervisory Control and Data Acquisition (SCADA) one-line diagram to identify the event location.

However, in such cases, identifying the event location based on patrolling the power lines or manually determining an event location by tracing a SCADA one-line diagram may be inefficient. As such, identifying the event location automatically using rule-based fault location algorithms or using machine learning techniques may be faster, more accurate, and less burdensome for the operator. However, rule-based event location algorithms may be computationally intensive for locating every single event. The burden of computationally intensive calculations may be shifted from the rule-based algorithms to a machine learning engine. Further, rather than checking electrical parameters including event status of every sensor in the sensor network system, checking the electrical parameters including the event status of a subset of the sensors using machine learning techniques may be sufficient to identify the event location. Even in cases where at least some of the sensors fail to report events, fail to function, and the like, the event location may still be identified correctly using machine learning techniques.

A training portion and a decision portion of machine learning may be implemented on separate hardware components. As used herein, the training portion of machine learning may be referred to as the machine learning engine, and the decision portion of machine learning may be referred to as the machine learning prediction engine or the machine learning decision engine. Machine learning may include generating a prediction model (e.g., machine learning model) based on training the machine learning engine in order to make predictions or decisions without being explicitly programmed to perform a task. For example, using the prediction model, the machine learning prediction engine may identify event locations. To identify the event locations via the machine learning prediction engine, the machine learning engine may be trained based on a topology of the electric power delivery system rather than historical data or live data. However, in some embodiments, the machine learning engine may also be trained based on historical data associated with operations of the sensor network system. The topology of the electric power delivery system may be generated by a graphical user interface (GUI), through which users may interactively create the topology. Additionally, the topology may be extracted from a file associated with commercially available modeling software. The topology may be categorized based on various line sections (e.g., labeled L1 to LN), and each line section may include any number of sensors. Further, the topology may indicate a phase (e.g., phase A, phase B, phase C) of each of the sensors. Such labeling within the topology may help the machine learning prediction engine in locating the event location. In some embodiments, the machine learning prediction engine may also be able to identify other event locations such as temporary faulted line sections and disturbed line sections if the sensors provide temporary fault and disturbance information.

After receiving the topology, processing circuitry may generate training matrices (e.g., matrix X, matrix Y). In some embodiments, the processing circuitry used to train the machine learning engine may be different from processing circuitry that hosts or contains the machine learning decision (or prediction) engine. Matrix Y may be column vector, where each row represents a different event location. Each row of the matrix X may indicate an event status of the sensor for each location. That is, each row shows an event indication of a sensor that was caused by an event at a line section. The matrix contains every possible or at least some possible event location given the available event status of sensors. That is, rather than collecting training data based on historical data (e.g., locations of actual events that have occurred in the past), the training data is generated based on every possible or at least some possible occurrences of event locations (e.g., faulted line sections) using the available status of the sensors. Such training data that takes into account every potential event location is used to train the machine learning engine.

The machine learning engine may be trained based on supervised training techniques such as logistic regression models (e.g., one-vs-rest logistic regression, regularized multinomial logistic regression). Logistic regression models may be simple and low in computational intensity, but have a high chance of accurately determining whether a location (e.g., line section) has an event. Based on such training of the machine learning engine and pattern recognition from data, the machine learning prediction engine may be faster and less computationally intensive at determining event locations compared to manual calculations or rule-based event location algorithms. This allows the machine learning engine and/or the machine learning prediction engine to be implemented in less powerful devices. Further, it can be appreciated that the machine learning prediction engine may become faster and more efficient at recognizing pattern related to event locations over time.

Using a prediction model that is generated from training the machine learning engine, the machine learning prediction engine may determine event locations. For example, after an actual event has occurred, the controller of the sensor network system may collect electrical parameters including the event status from the sensors. In some embodiments, the collector of the sensor network system may continue collecting electrical parameters including the event status from the sensors regardless of an occurrence of the actual event. Based on the event status of the sensors, the machine learning prediction engine may determine a likelihood of the event occurring at a location (e.g., line section). That is, after an event occurs, the machine learning prediction engine may determine respective probabilities for all or at least some of the possible event locations using the logistic regression models. Based on a location having a higher probability compared to other locations, the machine learning prediction engine may identify the location as an event location (e.g., faulted line section). A notification related to the location of the actual event may be transmitted to the controller of the sensor network system, Supervisory Control and Data Acquisition (SCADA) system, an operator of the electric power delivery system, and the like.

Moreover, the embodiments of the disclosure will be best understood by reference to the drawings, wherein like parts are designated by like numerals throughout. The components of the disclosed embodiments, as generally described and illustrated in the figures herein, could be arranged and designed in a wide variety of different configurations. Thus, the following detailed description of the embodiments of the systems and methods of the disclosure is not intended to limit the scope of the disclosure, as claimed, but is merely representative of possible embodiments of the disclosure. In addition, the steps of a method do not necessarily need to be executed in any specific order, or even sequentially, nor need the steps be executed only once, unless otherwise specified. In some cases, well-known features, structures or operations are not shown or described in detail. Furthermore, the described features, structures, or operations may be combined in any suitable manner in one or more embodiments. The components of the embodiments as generally described and illustrated in the figures could be arranged and designed in a wide variety of different configurations.

In addition, several aspects of the embodiments described may be implemented as software modules or components. As used herein, a software module or component may include any type of computer instruction or computer-executable code located within a memory device and/or transmitted as electronic signals over a system bus or wired or wireless network. A software module or component may, for instance, include physical or logical blocks of computer instructions, which may be organized as a routine, program, object, component, data structure, or the like, and which performs a task or implements a particular data type.

In certain embodiments, a particular software module or component may include disparate instructions stored in different locations of a memory device, which together implement the described functionality of the module. Indeed, a module or component may include a single instruction or many instructions, and may be distributed over several different code segments, among different programs, and across several memory devices. Some embodiments may be practiced in a distributed computing environment where tasks are performed by a remote processing device linked through a communications network. In a distributed computing environment, software modules or components may be located in local and/or remote memory storage devices. In addition, data being tied or rendered together in a database record may be resident in the same memory device, or across several memory devices, and may be linked together in fields of a record in a database across a network.

Thus, embodiments may be provided as a computer program product including a non-transitory, computer-readable and/or machine-readable medium having stored thereon instructions that may be used to program a computer (or other electronic device) to perform processes described herein. For example, a non-transitory computer-readable medium may store instructions that, when executed by a processor of a computer system, cause the processor to perform certain methods disclosed herein. The non-transitory computer-readable medium may include, but is not limited to, hard drives, floppy diskettes, optical disks, compact disc read-only memories (CD-ROMs), digital versatile disc read-only memories (DVD-ROMs), read-only memories (ROMs), random access memories (RAMs), erasable programmable read-only memories (EPROMs), electrically erasable programmable read-only memories (EEPROMs), magnetic or optical cards, solid-state memory devices, or other types of machine-readable media suitable for storing electronic and/or processor executable instructions.

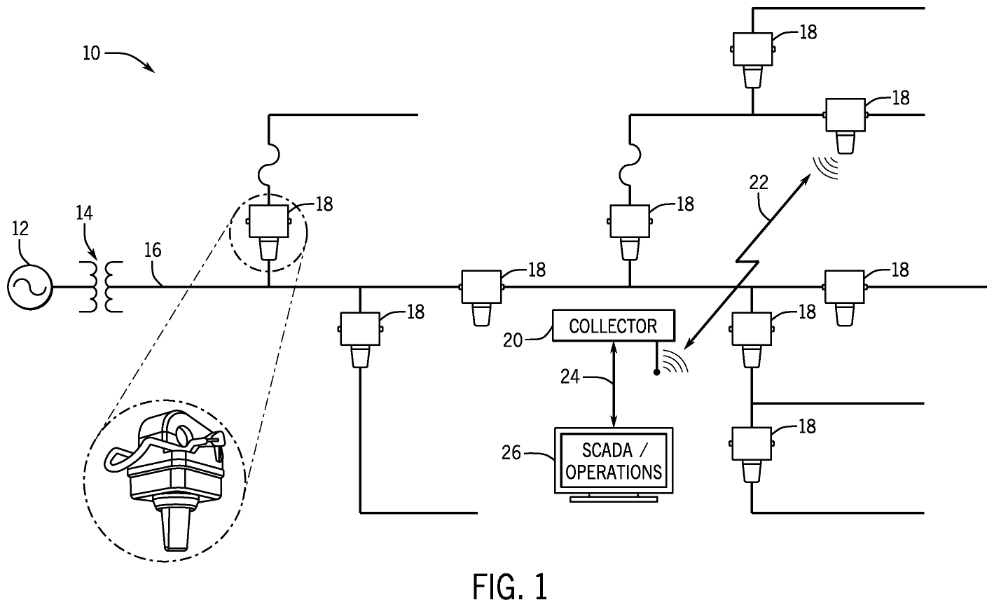

FIG. 1 is a schematic diagram of an electric power delivery system 10. The electric power delivery system 10 may receive electric power from a variety of generators. For example, electric power is shown in FIG. 1 as generated by a generator 12. A transformer 14 may step up or step down voltage from the generator 12 as specified for transmission through a power line 16. Dispersed at various locations throughout power lines of the electric power delivery system 10 are line sensors 18. The line sensors 18 may be able to obtain certain electrical measurements at the various locations. For example, the line sensors 18 may measure electrical current and/or voltage. The line sensors 18 may wirelessly transmit these measurements information to a line sensor collector 20 via a wireless (e.g., radio or optical) signal 22 or via wired communication. The line sensor collector 20 may also communicate via wired or wireless communication 24 with a Supervisory Control and Data Acquisition (SCADA) system 26 or a Real-Time Automation Controller (RTAC).

The line sensors 18, the line sensor collector 20, and/or the Supervisory Control and Data Acquisition (SCADA) system 26 may use the electrical measurements obtained by the line sensors 18 to determine an event at a line section. The line sensors 18 may also include indicator lights (e.g., light emitting diodes (LEDs)) that indicate the last event that was determined. In some embodiments, an event direction may be calculated by each line sensor 18. The indicator lights may remain visible after an event has occurred. When an event occurs, one line sensor 18 or a group of line sensors 18 may detect the event, display the event on indicator lights, and send the load and event location to the line sensor collector 20.

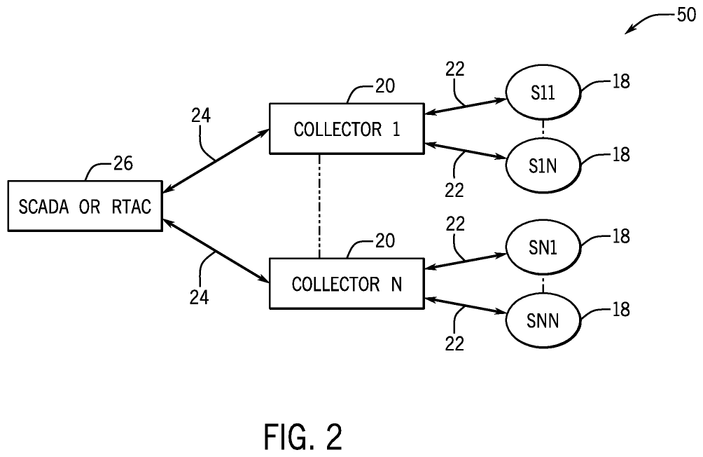

FIG. 2 is a diagram of the relationship between the Real-Time Automation Controller (RTAC) or Supervisory Control and Data Acquisition (SCADA) system 26, line sensor collectors 20, and line sensors 18. The Real-Time Automation Controller (RTAC) or Supervisory Control and Data Acquisition (SCADA) system 26 may communicate with any number of line sensor collectors 20 using the wired or wireless communication 24. Here, there are shown to be “N” line sensor collectors 20 labeled 1 . . . N. Each wireless line sensor collector 20 may communicate with any number of line sensors 18 via the wireless communication 22. Here, there are also shown to be “N” line sensors 18. For example, line sensors labeled S11 . . . S1N may be communicatively coupled to line sensor collector 20, labeled Collector 1. Further, line sensors labeled SN1 . . . SNN may be communicatively coupled to line sensor collector 20 labeled Collector N. Moreover, the line sensor collectors 20 may communicate with each other. Line sensors 18 that correspond to a particular line sensor collector 20 may also communicate with each other. However, the particular number “N” of wireless line sensors 18 may or may not be the same as the number “N” of wireless line sensor collectors 20. Moreover, there may be different number “N” wireless line sensors 18 per each wireless line sensor collector 20.

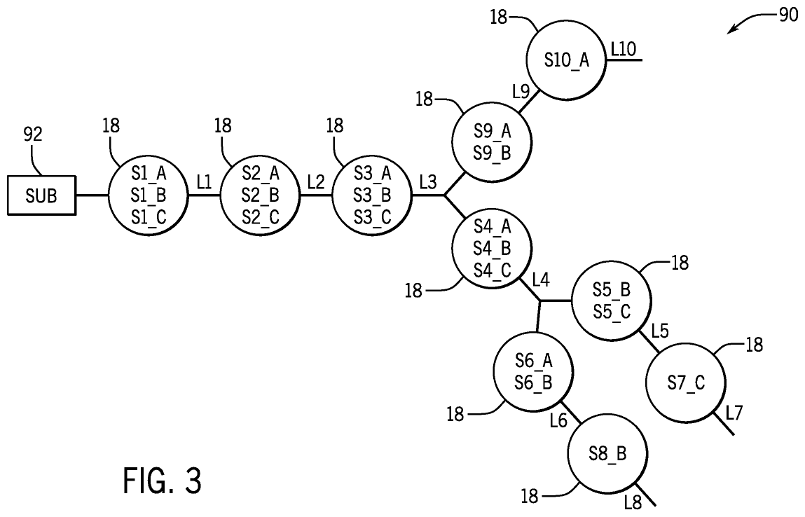

With the preceding in mind, FIG. 3 is an example schematic topology 90 of the electric power delivery system 10, in accordance with an embodiment. As mentioned above, the topology 90 may be generated based on user input via a graphical user interface (GUI), where users can interactively create the topology 90. The topology 90 may also be obtained from a commercially available modeling software. It should be noted that the schematic of FIG. 3 is simplified version of the topology 90. However, the topology 90 may be more complex and have numerous line sensors 18 and line sensor collectors 20.

As illustrated, each circle represents a set of line sensors 18. Each set of the line sensors may include one line sensor 18, two line sensors 18, three line sensors 18, or more. The set of line sensors 18 are communicatively coupled to a substation of 92 of the electric power delivery system 10. Among other things, the substation 92 regulates voltage of electrical power transmission and the like. Further, the topology 90 may be categorized based on line sections, which correspond to regions of the electric power delivery system 10. The topology 90 may include any number of line sections, labeled L1 . . . LN. Each line sensor 18 may be labeled based on which line section the line sensor 18 is located and which phase is associated with the line sensor 18. For example, the set of line sensors 18 associated with line section labeled L1 includes there line sensors 18, labeled S1_A, S1_B, and S1_C. Each of the three line sensors 18 are installed on phase A, phase B, and phase C, respectively. As illustrated, S1_A indicates that the line sensor 18 is located in L1 and installed on phase A. However, the naming for the topology may be more complex. For example, a name of a street, a pole, a feeder name, or any other suitable of naming convention may be used for the topology 90. As mentioned above, the naming convention of the line sections may help the machine learning prediction engine determine event locations.

Changes to the topology 90 may occur from time to time as the electric power delivery system 10 grows and changes. As the topology 90 is modified, the machine learning engine may be trained based on the modified topology 90. For example, any number of the line sensors 18 may be removed, added, or relocated in the electric power delivery system 10. To account for such changes in the topology 90, the machine learning engine may be re-trained based on the updated topology 90, such that the machine learning prediction engine may still accurately determine event locations.

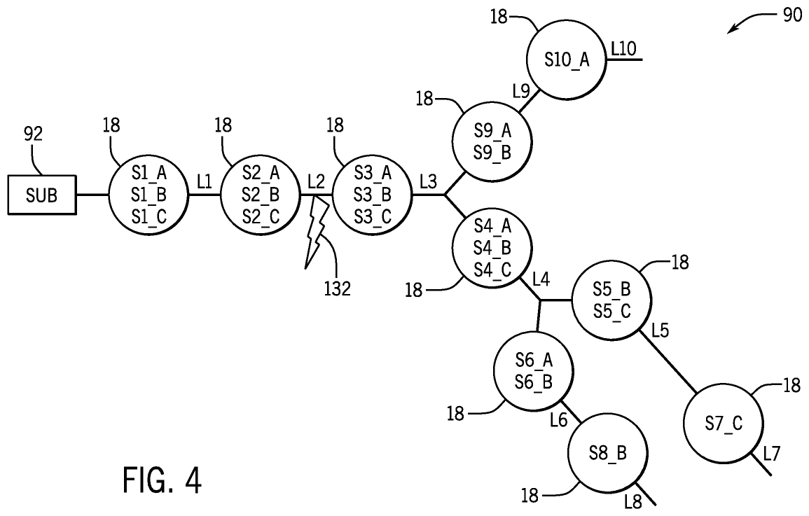

FIG. 4 is a view of the schematic topology 90 in which event locations 132 has been identified by a machine learning prediction engine. In one embodiment, the machine learning engine may identify a single event based on the event status of line sensors 18. That is, the machine learning prediction engine may identify one event at a time. For example, the machine learning prediction engine may identify the event location 132 (e.g., location of fault). In another embodiment, the machine learning prediction engine may identify a double event or a triple event that occurs at the same event location. For example, the machine learning prediction engine may identify two events, such as phase-to-phase faults, occurring at the event location 132, and three events occurring at the event location 132, such as three-phase faults. In some embodiment, the machine learning prediction engine may identity multiple events at different locations if the machine learning engine is trained to do so. Examples of the event location 132 are faulted line sections. The line sensors 18 may provide electrical measurements that, when used by the machine learning prediction engine, allow the machine learning prediction engine to rapidly detect the event location 132 at the indicated line section, as illustrated. The electrical parameters including the event status of the line sensors 18 may be used by the machine learning prediction engine to accurately identify the event location 132.

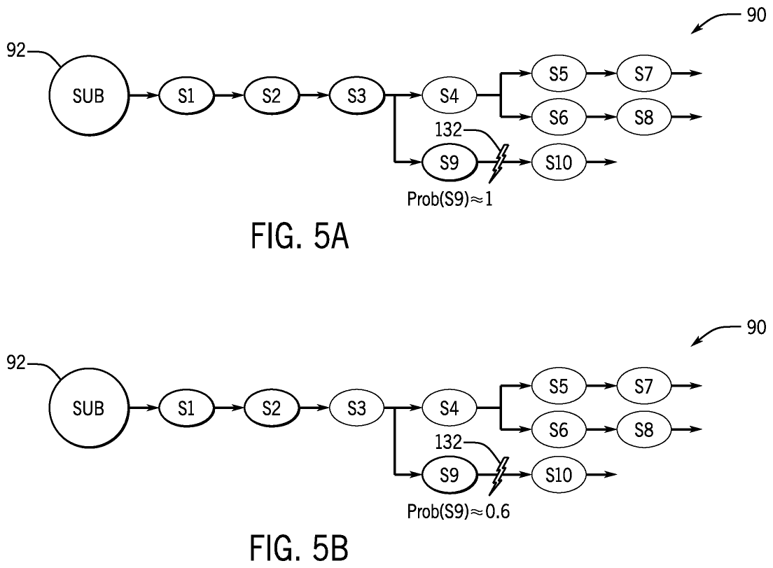

FIG. 5A is view of the schematic topology 90 in which a single event location 132 has been identified by a machine learning prediction engine. Based on the event status of the line sensors 18, the machine learning prediction engine determines a probability of 1 associated with event location 132 (e.g., likelihood of event occurring at line section between S9 and S10). Even if some of the line sensors 18 failed to provide electrical measurements or failed to detect an event (e.g., provided an inaccurate event status, failed to operate) in the electric power delivery system 10, the machine learning prediction engine may still identify the event locations (e.g., event location 132). FIG. 5B is a view of the schematic topology 90 in which event location 132 has been identified by the machine learning prediction engine despite a failed line sensor 18. As illustrated, even though S3 has failed to accurately sense an event, the machine learning prediction engine may correctly identify event location 132 based on the event status of other line sensors 18. However, the machine learning prediction engine may determine a probability (e.g., 0.6) of the event location 132 that is lower than the probability (e.g., 1) of FIG. 5A. Because S3 failed to detect the event, in which S3 had accurately sense an event.

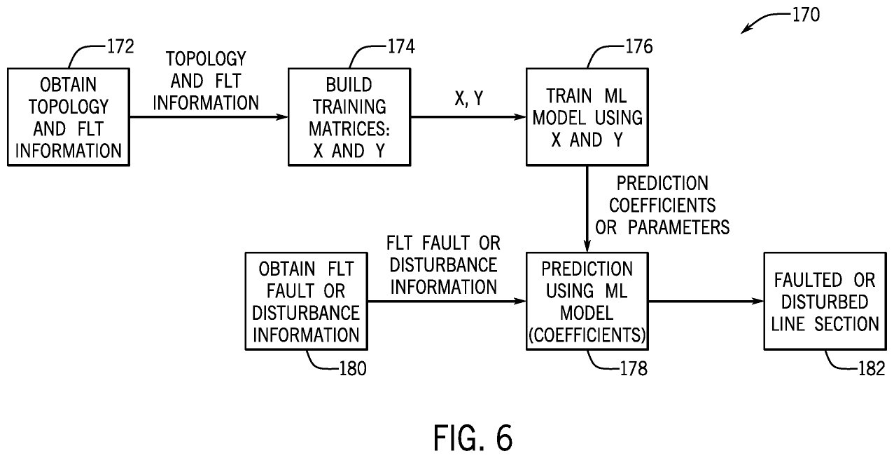

With the foregoing in mind, FIG. 6 is a flowchart of a process 170 used to determine a location of an event using machine learning techniques, in accordance with an embodiment. While the process 170 is described using steps in a specific sequence, it should be understood that the present disclosure contemplates that the described steps may be performed in different sequences than the sequence illustrated, and certain described steps may be skipped or not performed altogether. At block 172, processing circuitry (e.g., a computer processor, an application specific integrated circuit (ASIC), a field programmable gate array (FPGA)) may receive topology of an electric power delivery system that has been generated via user input or modeling software. As discussed in detail above, the topology may be categorized based on line sections that include any number of line sensors.

At block 174, the processing circuitry may use the generated topology to build training data (e.g., training matrices X and Y) to train a machine learning engine. The processing circuitry used to train the machine learning engine may be different from processing circuitry that hosts or contains the machine learning prediction engine. In some embodiments, the processing circuitry may generate the training data based on one or more simulations of possible events (e.g., faults) that could occur across the topology according to event status of the line sensors. The event status is based on whether a line sensor senses an event (e.g., fault) at a respective line section. In one example, matrix Y may be a column vector, where each row represents an event location (e.g., line section with an event). Each row of matrix X may contain event status indications of the line sensors that were caused by an event that corresponds to each row of the matrix Y. That is, each row shows event (e.g., a fault) indications of a set of line sensors that was caused by an event (e.g., a fault) along a line (e.g., 1 indicates an event, 0 indicates no event). The matrix may contain one event location or simultaneous event locations (e.g., every possible fault location) given different statuses of the line sensors 18. That is, rather than collecting training data based on historical data (e.g., locations of actual events that have occurred in the past), the training data may be generated based on every potential occurrence of an event location using the status of the line sensors 18. Such training data that takes into account every potential event location may be used to train the machine learning engine.

The matrix X and Y may be generated based on the number of phases of the electric power delivery system (e.g., phase A, phase B, phase C). For example, the following matrix X and matrix Y may be generated for phase A in a very small example electric power delivery system with only a few line sensors. It should be understood larger electric power systems with may become much more complex. The following matrix X and matrix Y may be generated for phase A:

| | S1 | S2 | S3 | S4 | S6 | S9 | S10 | | Y |
|---|---|---|---|---|---|---|---|---|---|
| 1 | 1 | 0 | 0 | 0 | 0 | 0 | 0 | L1 | 1 |
| 2 | 1 | 1 | 0 | 0 | 0 | 0 | 0 | L2 | 2 |
| 3 | 1 | 1 | 1 | 0 | 0 | 0 | 0 | L3 | 3 |
| 4 | 1 | 1 | 1 | 1 | 0 | 0 | 0 | L4 | 4 |
| 5 | 1 | 1 | 1 | 1 | 1 | 0 | 0 | L6 | 6 |
| 6 | 1 | 1 | 1 | 0 | 0 | 1 | 0 | L9 | 9 |
| 7 | 1 | 1 | 1 | 0 | 0 | 1 | 1 | L10 | 10 |

The top row of matrix X (S1 . . . S10) represents each of the line sensors, and the left column of matrix X (1 . . . 7) indicates the number of event locations for phase A. The matrix X is a 7 by 7 matrix with 7 event locations. The matrix Y is a column vector, which indicates the possible event locations or line section with possible events (e.g., L1, L2, L3, L4, L6, L9, and L10) according to sensing capabilities of the line sensors. As mentioned above, “1” indicates an event (e.g., the event sensed by a line sensor), and “0” indicates no event (e.g., no event sensed by a line sensor).

By way of example, it can be assumed that each line sensor is capable of providing accurate event status (e.g., accurately sensing an event when an event occurs). For example, line sensor 1 (e.g., S1) may sense an event (e.g., as indicated by “1” in the first row of matrix X) while the other line sensors (e.g., S2, S3, S4, S6, S9, and S10) may not sense the event (e.g., as indicated by “0” in the first row of matrix X). Because only S1 sensed the event, the machine learning prediction engine may determine that L1 (e.g., line section between S1 and S2 as shown in the topology 90 of FIG. 3) is the event location based on a probability associated with L1 (e.g., as indicated by “1” in the first row of matrix Y). Further, line sensors 1 and 2 (e.g., S1 and S2) may sense an event while the other line sensors (e.g., S3, S4, S6, S9, and S10) may not sense the event. Based on the event status of each of the line sensors (e.g., including S1 and S2 sensing the event), the machine learning prediction engine may determine L2 (e.g., line section between S2 and S3 as shown in the topology 90 of FIG. 3) as the event location. In response to line sensors 1, 2, and 3 (e.g., S1, S2, and S3) sensing an event but other line sensors (e.g., S4, S6, S9, and S10) not sensing the event, the machine learning prediction engine may determine L3 (e.g., line section between S3 and S4 as shown in the topology 90 of FIG. 3) as the event location.

Moreover, based on line sensors 1, 2, 3, and 9 (e.g., S1, S2, S3, and S9) sensing an event but other line sensors (e.g., S4, S6, and S10) not sensing the event, the machine learning prediction engine may determine L9 (e.g., line section between S9 and S10 as shown in the topology 90 of FIG. 3) as the event location. According to the topology 90 of FIG. 3, line sensors 9 and 10 (e.g., S9 and S10) are on a different path or line compared to line sensors 4 and 6 (e.g., S4 and S6). As such, line sensors 4 and 6 may not sense the event since line sensors 4 and 6 are on a different path compared to line sensors 9 and 10. Further, in response to line sensors 1, 2, 3, 9, and 10 (e.g., S1, S2, S3, S9, and S10) sensing an event but other line sensors (e.g., S4, and S6) not sensing the event, the machine learning prediction engine may determine L10 as the event location. Similar to the previous example, since line sensors 4 and 6 are on a different path or line compared to line sensors 9 and 10, line sensors 4 and 6 may not sense the event.

The following matrix X and matrix Y may be generated for phase B:

| | S1 | S2 | S3 | S4 | S5 | S6 | S8 | S9 | | Y |
|---|---|---|---|---|---|---|---|---|---|---|
| 1 | 1 | 0 | 0 | 0 | 0 | 0 | 0 | 0 | L1 | 1 |
| 2 | 1 | 1 | 0 | 0 | 0 | 0 | 0 | 0 | L2 | 2 |
| 3 | 1 | 1 | 1 | 0 | 0 | 0 | 0 | 0 | L3 | 3 |
| 4 | 1 | 1 | 1 | 1 | 0 | 0 | 0 | 0 | L4 | 4 |
| 5 | 1 | 1 | 1 | 1 | 1 | 0 | 0 | 0 | L5 | 5 |
| 6 | 1 | 1 | 1 | 1 | 0 | 1 | 0 | 0 | L6 | 6 |
| 7 | 1 | 1 | 1 | 1 | 0 | 1 | 1 | 0 | L8 | 8 |
| 8 | 1 | 1 | 1 | 0 | 0 | 0 | 0 | 1 | L9 | 9 |

The matrix X and the matrix Y for phase B represented 8 event locations.

The following matrix X and matrix Y may be generated for phase C:

| | S1 | S2 | S3 | S4 | S5 | S7 | | Y |
|---|---|---|---|---|---|---|---|---|
| 1 | 1 | 0 | 0 | 0 | 0 | 0 | L1 | 1 |
| 2 | 1 | 1 | 0 | 0 | 0 | 0 | L2 | 2 |
| 3 | 1 | 1 | 1 | 0 | 0 | 0 | L3 | 3 |
| 4 | 1 | 1 | 1 | 1 | 0 | 0 | L4 | 4 |
| 5 | 1 | 1 | 1 | 1 | 1 | 0 | L5 | 5 |
| 6 | 1 | 1 | 1 | 1 | 1 | 1 | L6 | 6 |

The matrix X and the matrix Y for phase C represented 6 event locations.

At block 176, the processing circuitry may train the machine learning engine using the matrix X and the matrix Y based on any suitable training method. In one example, the machine learning engine is trained using supervised machine learning. In supervised machine learning, a mathematical model of a set of data may contain both the inputs and the desired outputs. This data is referred to as training data and is essentially a set of training examples. Each training example has one or more inputs and the desired output. In a mathematical model, each training example is represented by an array or vector, sometimes called a feature vector, and the training data is represented by a matrix (e.g., matrix X and matrix Y). Through iterative optimization of an objective function, supervised learning algorithms learn a function that can be used to predict the output associated with new inputs. An optimal function will allow the algorithm to correctly determine the output for inputs that were not a part of the training data. An algorithm that improves the accuracy of its outputs or predictions over time is said to have learned to perform that task.

Classification and regression are examples of forms of training for supervised machine learning. Classification algorithms are used when the outputs are restricted to a limited set of values, and regression algorithms are used when the outputs may have any numerical value within a range. Similarity learning is an area of supervised machine learning closely related to regression and classification, but the goal is to learn from examples using a similarity function that measures how similar or related two objects are.

In one example, the machine learning engine may be trained using logistic regression models such as regularized one-vs-rest and regularized multinomial. One-vs-rest is a binary classification logistic regression, which divides the test cases or event status (e.g., the rows of the matrix X) into a set of two classes. One class includes a test case and the other class includes the rest of test cases. After dividing the test cases, the algorithm classifies each test case against the rest of the test cases. Moreover, the multinomial logistic regression is a multi-class classification logistic regression. The output of both regularized one vs. rest and regularized multinomial is a matrix (e.g., matrix K). For a three-phase system, the three matrices may be output (e.g., matrix K_A, matrix K_B, matrix K_C). The regularized parameter (e.g., fitting parameter) may be adjusted such that either of the logistic regression algorithms generates the maximum probability for each test case (e.g., close to 1 for the test case and close to 0 for the rest of the cases). Based on the values of the matrix, the machine learning engine may be trained to determine potential event locations at block 178. In other embodiments, algorithms such as support vector machine (SVM) regression model may also be used to train the machine learning engine.

The following are examples of the matrix K_A, the matrix K_B, and the matrix K_C:

K_A =

| | | | | | | | |
|---|---|---|---|---|---|---|---|
| 4.6417 | 0.0000 | −9.5490 | −2.2107 | −0.7005 | −0.2984 | −0.7005 | −0.2984 |
| −4.7347 | 0.0032 | 8.7374 | −9.1512 | −1.6813 | −0.5973 | −1.6813 | −0.5973 |
| −6.4896 | 0.0058 | 1.5369 | 8.5800 | −8.5811 | −1.5329 | −8.5811 | −1.5329 |
| −7.3730 | −0.0314 | 0.5844 | 1.6769 | 9.1448 | −8.7302 | −1.6799 | −0.5968 |
| −26.6313 | −0.0001 | −0.0000 | −0.0000 | −0.0000 | 0.0000 | −0.0000 | 0.0000 |
| −8.1139 | −0.0015 | 0.2970 | 0.7004 | 2.2100 | 9.5498 | −0.6999 | −0.2981 |
| −26.6313 | −0.0001 | −0.0000 | −0.0000 | −0.0000 | 0.0000 | −0.0000 | 0.0000 |

K_B =

| | | | | | | | | |
|---|---|---|---|---|---|---|---|---|
| 4.6418 | −0.0003 | −9.5506 | −2.2261 | −0.9415 | −0.2435 | −0.3875 | −0.1767 | −0.4835 |
| −4.7045 | −0.0274 | 8.7384 | −9.1541 | −1.9811 | −0.4891 | −0.6944 | −0.2961 | −1.4111 |
| −6.4009 | −0.0582 | 1.5147 | 8.5769 | −8.7927 | −1.4058 | −1.6721 | −0.5954 | −8.4010 |
| −7.5001 | 0.0514 | 0.6135 | 1.6764 | 8.7916 | −8.4032 | −8.5768 | −1.5296 | −1.4061 |
| −8.1169 | 0.0005 | 0.2992 | 0.7016 | 2.0085 | 9.7298 | −1.7034 | −0.6029 | −0.4950 |
| −7.9721 | −0.0669 | 0.2557 | 0.6744 | 1.9665 | −1.3966 | 9.1505 | −8.7356 | −0.4869 |
| −26.3153 | −0.0000 | 0.0000 | −0.0000 | −0.0000 | −0.0000 | −0.0000 | −0.0000 | 0.0000 |
| −8.6436 | −0.0009 | 0.1796 | 0.3878 | 0.9412 | −0.4886 | 2.2260 | 9.5523 | −0.2436 |

K_C =

| | | | | | | |
|---|---|---|---|---|---|---|
| 4.6433 | 0.0010 | −9.5223 | −1.9692 | −0.9078 | −0.4794 | −0.2141 |
| −4.7306 | 0.0002 | 8.7463 | −8.9606 | −1.8899 | −0.8150 | −0.3391 |
| −6.4638 | 0.0007 | 1.5582 | 8.9122 | −8.9428 | −1.8070 | −0.6287 |
| −7.3442 | −0.0172 | 0.6214 | 1.8054 | 8.9424 | −8.9141 | −1.5521 |
| −7.7997 | −0.1015 | 0.2869 | 0.7895 | 1.8813 | 8.9643 | −8.7473 |
| −8.4463 | −0.0004 | 0.2131 | 0.4787 | 0.9076 | 1.9693 | 9.5227 |

After training the machine learning engine, the machine learning engine may be programmed into a Supervisory Control and Data Acquisition (SCADA) system or any suitable circuitry (e.g., an application specific integrated circuit (ASIC), a field programmable gate array (FPGA), a central processing unit (CPU), graphical processing unit (GPU)) that connects to the Supervisory Control and Data Acquisition (SCADA) system to determine locations of events. For example, after an actual event has occurred, the processing circuitry of a controller of a sensor network system may collect the event status of the line sensors at block 180. The processing circuitry or the controller may output a number of vectors depending on the type of event. For example, one vector may be output based on a single-phase to ground event. Two vectors may be output based on a two-phase event (e.g., phase-to-phase or a phase-to-phase-to-ground event). Three vectors may be output based on a three-phase event.

For example, based on the matrix K_B and the matrix K_C, if we have a phase-to-phase (phase B and C) event at L5, the processing or the controller may output the following result vectors:

VB=[1 1 1 1 1 0 0 0] and VC=[1 1 1 1 1 0]

Based on the vectors output at block 180 (e.g., event status of the line sensors) and the matrices outputted at block 176 (e.g., fitting parameter) of the machine learning engine (e.g., training portion of the machine learning), the machine learning prediction engine may determine a location of the actual event at block 182. The product of the vectors outputted at block 180 and the matrices outputted at block 176 (e.g., result vector) helps the machine learning prediction engine determine the one or more event locations. With a single-phase event (e.g., one result vector), the machine learning prediction engine may determine one event location. With two-phase events, (e.g., two result vectors) the machine learning prediction engine may determine two events for the same location, and with three-phase events (e.g., three result vectors), the machine learning prediction engine may determine three events for the same location.

Based the result vector, a probability closer to 1 indicates a higher likelihood of an event location. As shown in the example below with two result vectors, the machine learning prediction engine identifies L5 as the event location for both phases B and C. The probability of the event occurring at line section L5 is 0.9903 for phase B and is 0.9824 for phase C, which are close to 1. In some embodiments, such probabilities may be calculated by applying a sigmoid function to the outputs of the result vectors.

prob_B =

| | | | | | | | |
|---|---|---|---|---|---|---|---|
| 0.0002 | 0.0005 | 0.0014 | 0.0084 | 0.9903 | 0.0014 | 0.0000 | 0.0005 |

faulted_Line_section =
prob_C =

| | | | | | |
|---|---|---|---|---|---|
| 0.0003 | 0.0005 | 0.0012 | 0.0073 | 0.9824 | 0.0076 |

faulted_Line_section =

In some embodiments, the processing circuitry may send a notification related to the location of the actual event (s) to the controller of the sensor network system, Supervisory Control and Data Acquisition (SCADA) system, an operator of the electric power delivery system, or the like. In additional and/or alternative embodiments, the machine learning prediction engine may determine temporary faulted line sections or disturbed line sections. Further, the machine learning prediction engine may help identify a failed line sensor (e.g., line sensor failed to report a fault).

It can be appreciated that the machine learning prediction engine can identify event locations without training the machine learning engine based on collecting historical data that indicates occurrences of with previous event locations (but historical data may be used in addition or as an alternative to the matrices of possible results discussed above). After an event occurs, the machine learning prediction engine may determine a probability or likelihood for all or at least some of the possible event locations as discussed above. Based on one location having a higher probability compared to other locations, the machine learning prediction engine may identify the location with the higher probability as an event location (e.g., a faulted line section). In addition to classifying the location (e.g., line section) with the highest probability compared to other locations as the event location, the machine learning prediction engine may compare a respective probability of a location to a threshold probability (e.g., 0.2, 0.3, 0.4). For example, if a location has a probability that is less than the threshold probability, then the machine learning engine may not classify the location as the event location even though the probability of the location is higher compared to probabilities of other locations. That is, the machine learning prediction engine may be less deterministic in classifying the location as the event location when the probability of the location is lower than the threshold probability. One or more faulty line sensors that provided inaccurate event status, for example, may result in the probability of the location being lower than the threshold probability. Further, the machine learning engine and the machine learning prediction engine may be implemented on one or more hardware components. For example, the training portion of the machine learning engine (e.g., machine learning engine) may be implemented on a different hardware component (e.g., server) compared to the decision portion of the machine learning engine (e.g., machine learning prediction engine). In other embodiments, the machine learning engine may implemented as a host in the cloud or as a software as a service (SAAS).

While specific embodiments and applications of the disclosure have been illustrated and described, it is to be understood that the disclosure is not limited to the precise configurations and components disclosed herein. For example, the systems and methods described herein may be applied to an industrial electric power delivery system or an electric power delivery system implemented in a boat or oil platform that may or may not include long-distance transmission of high-voltage power. Accordingly, many changes may be made to the details of the above-described embodiments without departing from the underlying principles of this disclosure. The scope of the present disclosure should, therefore, be determined only by the following claims.

Indeed, the embodiments set forth in the present disclosure may be susceptible to various modifications and alternative forms, specific embodiments have been shown by way of example in the drawings and have been described in detail herein. However, it may be understood that the disclosure is not intended to be limited to the particular forms disclosed. The disclosure is to cover all modifications, equivalents, and alternatives falling within the spirit and scope of the disclosure as defined by the following appended claims. In addition, the techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112(f). For any claims containing elements designated in any other manner, however, it is intended that such elements are not to be interpreted under 35 U.S.C. 112(f).

What is claimed is:

1. A non-transitory machine-readable medium, comprising machine-readable instructions that, when executed by one or more processors, cause the one or more processors to:
receive a topology of an electric power delivery system;
generate one or more training matrices based on the topology, wherein the one or more training matrices indicate possible events at respective line sections of a plurality of line sections; and
train a machine learning engine based on the one or more training matrices to identify an event location.

2. The machine-readable medium of claim 1, wherein the event location comprises a faulted line section.

3. The machine-readable medium of claim 1, wherein the topology indicates a number of sensors located at each of the plurality of line sections and a type of phase associated with each of the number of sensors.

4. The machine-readable medium of claim 1, comprising machine-readable instructions that cause the one or more processors to train the machine learning engine based on a regularized one-vs-rest logistic regression model, a regularized multinomial logistic regression model, a support vector machine (SVM) regression model, or any combination thereof.

5. The machine-readable medium of claim 1, comprising machine-readable instructions that cause the one or more processors to:
receive user input to modify the topology;
modify the one or more training matrices based on the user input; and
update the machine learning engine based on the one or more training matrices being modified.

6. The machine-readable medium of claim 5, wherein modifying the topology comprises adding at least one sensor to the electric power delivery system, removing at least one sensor from the electric power delivery system, relocating at least one sensor in the electric power delivery system, or any combination thereof.

7. A computing device, comprising:
processing circuitry that comprises a machine learning prediction engine, wherein the processing circuitry is configured to:
acquire electrical parameters of one or more sensors associated with a line section of a plurality of line sections in an electric power delivery system;
determine, using the machine learning prediction engine, a likelihood of an event occurring at the line section of the plurality of line sections based on the electrical parameters; and
provide, to a client device, an indication of the line section as an event location based on the likelihood of the event occurring at the line section being greater than respective likelihoods of the event occurring at other line sections of the plurality of line sections.

8. The computing device of claim 7, wherein the one or more sensors comprise one or more wireless line sensors, one or more intelligent electronic devices, one or more relays, or any combination thereof.

9. The computing device of claim 7, wherein the electrical parameters comprise an event status for the line section, wherein the event status indicates whether the event occurred at the line section according to the one or more sensors.

10. The computing device of claim 7, wherein the processing circuitry is configured to:
determine, using the machine learning prediction engine, the likelihood of the event occurring at the line section; and
provide, to the client device, an indication of the line section as the event location despite at least one of the one or more sensors failing to operate or providing an inaccurate event status of the line section.

11. A system comprising:
a plurality of sensors, wherein each of the plurality of sensors is configured to be located at respective line sections of a plurality of line sections of an electric power delivery system; and
a controller communicatively coupled to the plurality of sensors, wherein the controller is configured to:
acquire electrical parameters, event status, or both from at least some of the plurality of sensors for the respective line sections of the plurality of line sections; and
determine, via a prediction model, a line section of plurality of line sections identified as an event location based on a probability of an event occurring at the line section being greater than probabilities of other line sections of the plurality of line sections.

12. The system of claim 11, comprising processing circuitry configured to train a machine learning engine to generate the prediction model is based on:
receiving a topology of the electric power delivery system from user input via a graphical user interface;
generating one or more training matrices based on the topology and a simulation of possible event locations, wherein the one or more training matrices indicate at least one possible event location; and
training the machine learning engine using the one or more training matrices.

13. The system of claim 12, wherein the topology indicates a number of the plurality of sensors at the respective line sections and a type of phase of each of the plurality of sensors.

14. The system of claim 12, wherein the processing circuitry is configured to train the machine learning engine using a logistic regression model.

15. The system of claim 11, wherein the system comprises a first hardware component for training the machine learning engine and a second hardware component for determining the event location using the prediction model.

16. The system of claim 11, wherein the machine learning engine is implemented on a cloud server.

17. A method, comprising:
receiving, via processing circuitry, a topology of an electric power delivery system;
generating, via the processing circuitry, one or more training matrices based on the topology; and
training, via the processing circuitry, a machine learning engine using the one or more training matrices to determine a likelihood of an event location within the electric power delivery system.

18. The method of claim 17, wherein the one or more training matrices are based on every potential occurrence of the event location.

19. The method of claim 17, wherein the topology comprises a relationship between a plurality of line sections and a corresponding plurality of line sensors associated with the electric power delivery system.

20. The method of claim 17, wherein the one or more training matrices are based on phases of the electric power delivery system.
